(19) United States
(12) Patent Application Publication
(10) Pub. No.: US 2013/0316306 A1
(43) Pub. Date: Nov. 28, 2013

(54) Method And Apparatus For Preparing A Zirconia Dental Restoration In One Appointment

(71) Applicants: Robin A. Carden, San Juan Capistrano, CA (US); Michael J. Selberis, Ladera Ranch, CA (US)

(72) Inventors: Robin A. Carden, San Juan Capistrano, CA (US); Michael J. Selberis, Ladera Ranch, CA (US)

(73) Assignee: James R. Glidewell Dental Ceramics, Inc.

(21) Appl. No.: 13/481,811

(22) Filed: May 26, 2012

(51) Int. Cl. A61C 13/08

(52) U.S. Cl. 433/203.1

(57) ABSTRACT

A method and apparatus that permits a dentist to provide a patient with a monolithic zirconia restoration (i.e., crown) in one office visit. The dentist is provided with a kit of various near net shape (NNS) components of various shapes and shades, chair-side software, and a chair-side milling machine to convert a selected kit component into a finished, fully contoured restoration in about one hour or less. Each such kit component may be, for example, a fully sintered zirconia NNS component having an integral mandrel at a precise location and orientation to minimize the amount of milling time.

### BACKGROUND OF THE INVENTION

1. Field of the Invention

The present invention relates generally to the field of restorative dentistry. The invention herein relates more specifically to the extremely rapid fabrication of zirconia dental restorations to permit preparation of, for example, zirconia crowns in a dental office during a single visit by a patient.

2. Background Discussion

There are several important advantages to zirconia dental restorations that make them ideal material for use as dental crowns, bridges and the like. First, they are very strong and therefore highly resistant to chipping, breakage and wear. The assignee hereof has achieved a flexure strength exceeding 1600 MPa in monolithic zirconia crowns. Second, they can be shaped, sized and colored to take on a natural appearance that is essentially undistinguishable from the original teeth they restore or replace. Third, they can be fabricated in a manner which results in a cost effective restoration when compared to conventional materials such as PFM.

There is yet another potential fourth advantage which has not been fully realized in the dental restoration art. This advantage would, if achievable, result from the qualities of a monolithic ceramic material, namely zirconia, which can be fabricated in distinct steps that need not be accomplished all at one time. This advantage would be realized at the dentist's office where it would significantly reduce the time required to fully fabricate a patient/tooth specific finished restoration within a time period so short that it can be conveniently accomplished while the patient is in the dental office and even while in the dental chair. Such time periods to be practical would have to be one hour or less, including the time a patient first sits in a dental chair to be examined for a new crown and until that same patient exits the dental chair with a newly installed crown. And not just any standard crown, but one that is stronger, equal to, or better than the natural tooth in appearance and reasonably priced, or even less costly than conventional crowns. Such an invention could realistically change a significant part of the dental profession and the dental laboratory industry.

### SUMMARY OF THE INVENTION

The present invention comprises a method and apparatus for actually achieving the fourth advantage alluded to above. We start with the method, the first step of which is to fabricate a near net shape (NNS), fully sintered, monolithic zirconia restoration (i.e., crown) of selected shading and having an integral zirconia mandrel. The mandrel extends from a selected location on the restoration NNS and at a precisely known angle. The second and subsequent steps of the inventive method comprise fabricating other NNS zirconia restorations of selected shading and having an integral zirconia mandrel, until a plurality of such restorations may be assembled to form a kit having each and every likely general shape and shading of zirconia restoration that may be needed for the vast majority of patients a dentist is likely to see in the course of his or her practice. It will be seen hereinafter that for single tooth crowns, there are up to seventy variations of combined shape and shading in a minimum kit. Such a kit would be kept in a dentist's office along with a chair-side milling machine to be described hereinafter.

The next step in the method of a preferred embodiment of the present invention is an optical scan of the patient's mouth adjacent the tooth to be restored. An Impression can also be used to generate the scanning file. This scan generates data which is sent to a computer with designing software which could be located at the doctor's office or in the cloud via an internet connection. The dental office, the lab/assignee, or the automated process in the cloud hereof then generates a corresponding file to control the aforementioned milling machine and indicates appropriate shape to be used from the kit. The appropriate digital milling strategy is calculated either by the software located in the doctor's office, dental lab or via the cloud service and is sent electronically to the dentist's office milling machine to control the machine's conversion of the selected NNS kit component to a finished restoration which may need only slight polishing, or glazing to complete after the integral mandrel is separated from the milled restoration's surface.

A critical aspect of the method hereof is the time required to convert the NNS kit component to a finished restoration. Current milling strategies involve milling a porous zirconia body and then sintering at high temperatures, 1300-1600 C, which takes many hours to complete. A porous “Block body shape” is used because of the time it takes to mill a fully dense restoration which is usually many hours and expensive because of the many diamond burrs. Because the kit component is near net shape, the amount of zirconia material to be removed by the chair-side milling machine is minimal. The integral mandrel further reduces the amount of zirconia material that needs to be removed because there is no significant angular error or imprecision between the mandrel and the restoration. Because the total amount of material to be removed is only at most a few grams, the time required using the chair-side milling machine to convert the kit component to a finished restoration is typically less than ten minutes. The apparatus hereof comprises the kit and the chair-side milling machine at a dentist's office and the dental office, laboratory or cloud-located software for converting a patient's mouth scan data into a kit component selection and milling machine instructions to mill the restoration.

In order to minimize the amount of excess material that will need to be removed in the chair-side milling machine and still require a kit having only a reasonable number of near net shape components, the preferred embodiment of the invention employs a universal NNS configuration derived from a large database of possible tooth shapes and sizes. In one embodiment, each such NNS component is derived from a composite of literally thousands of actual teeth of each type, i.e., upper molar, lower molar, incisors, etc. That composite is then smoothed by filling between peaks to provide an NNS component that is easy to manufacture by an efficient process such as by injection molding and then fully sintered and placed into the kit with one of various alternative shading colors to provide a starting work piece for the chair-side milling step. A suitable chair-side milling machine is disclosed in co-pending patent application Ser. No. ______ filed on ______.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a composite photograph showing prior art block and milling components of the prior art and an inventive embodiment hereof and the finished restoration therefrom;

FIGS. 2 through 5 are drawings of a crude shape molar corresponding to a step in the creation of an NNS component according to one embodiment of the invention;

FIGS. 6 through 10 are drawings of a final shape molar corresponding to another step in the creation of an NNS component;

FIG. 11 is a drawing of a chair-side milling machine according to one embodiment hereof; and

FIG. 12 is a flow chart drawing of a preferred embodiment of the process of the invention.

### DETAILED DESCRIPTION OF A PREFERRED EMBODIMENT

Referring to the accompanying drawings, it will be seen that an important aspect of the present invention is the reduction in the time required to prepare a finished zirconia restoration. One of the reasons why zirconia has become such a desirable material for use in restorative dentistry is its strength and durability. However, this feature also makes it more difficult to machine such as by milling after it has been fully sintered. Milling any significant amount of material from a fully sintered zirconia block, can be a time-consuming process that would ordinarily make it impractical to provide a finished zirconia restoration within one patient visit. The conventional approach has been to shape the zirconia while it is only partially sintered and therefore more readily milled. However, such a two-step approach makes it impractical to complete a finished fully formed zirconia restoration during one patient visit without having a sintering oven on the premises. While the assignee hereof has designed such an oven that is capable of high speed sintering at a dental office, there may be some reluctance among dentists to have to deal with a high temperature, high power apparatus at their facility and to calculate sintering induced shrinkage resulting from full sintering. Therefore, the present invention is designed to make it practical for dentists to work with fully sintered components, which because of their unique near net shape configuration and integral mandrel, make it possible to mechanically finish the restoration in a relatively brief period of time. The key therefore is to furnish the dentist with fully sintered, near net shape zirconia starting components which significantly reduce the amount of material that needs to be removed to complete the restoration. The present invention achieves this key goal by employing one or both of two innovative measures.

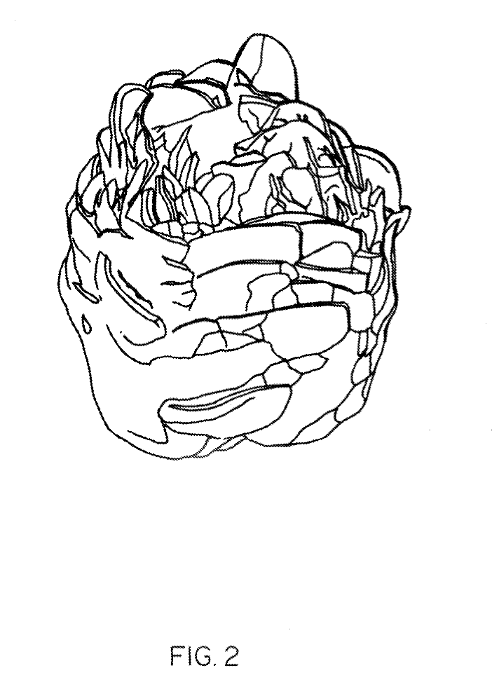

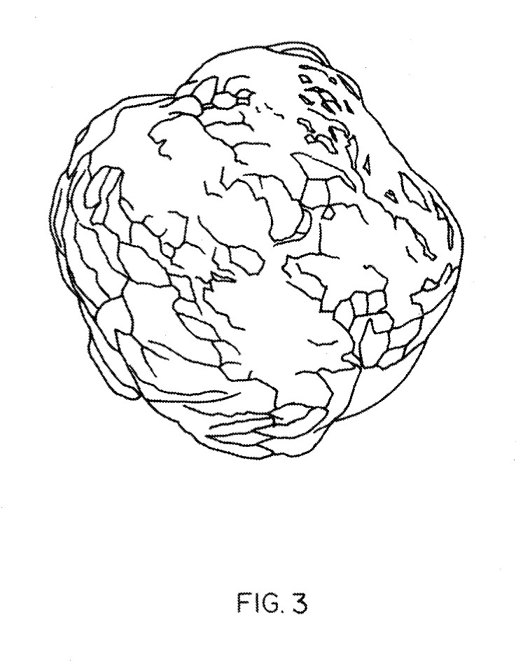

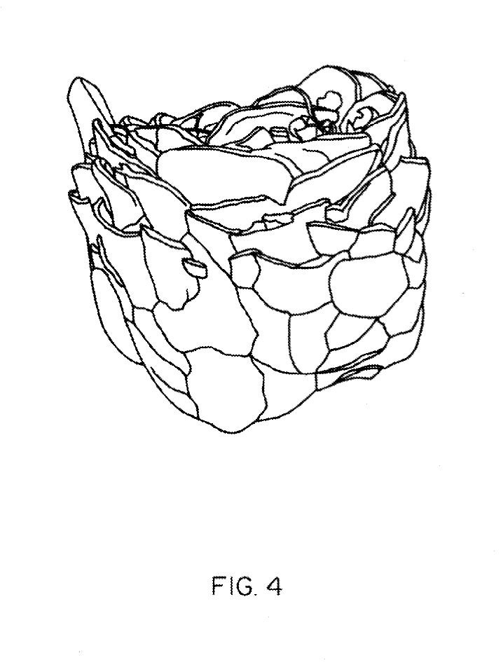

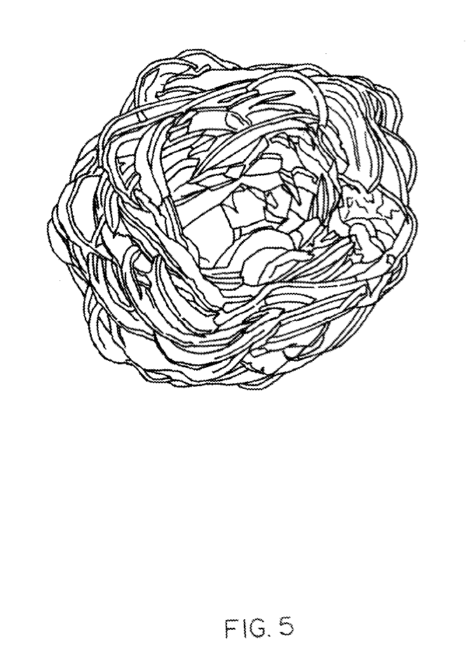

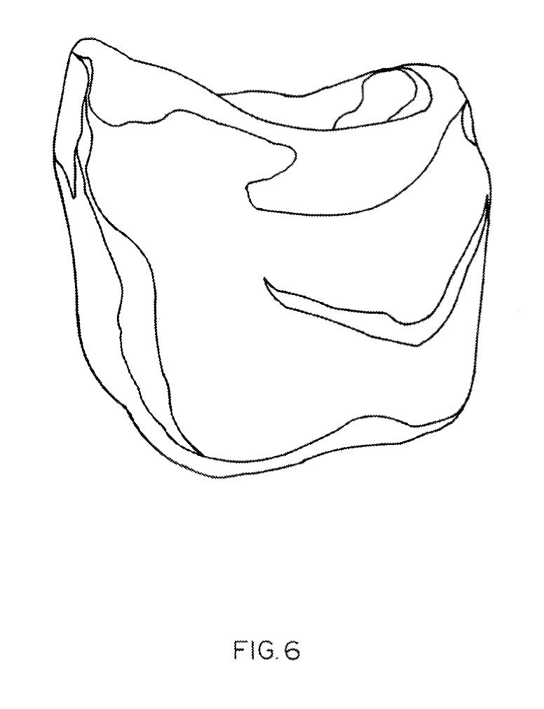

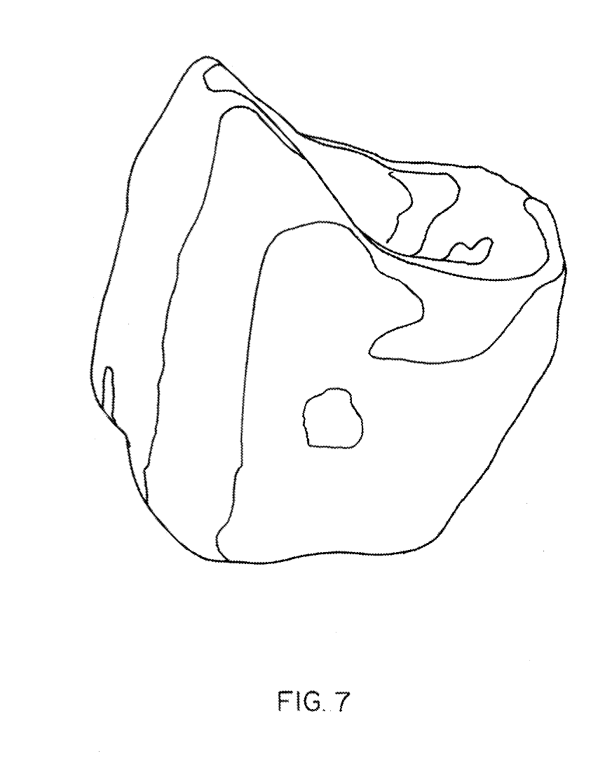

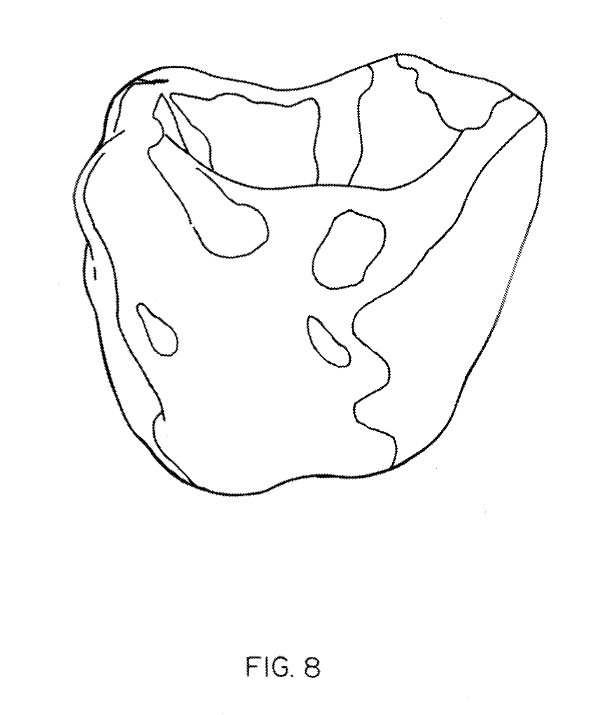

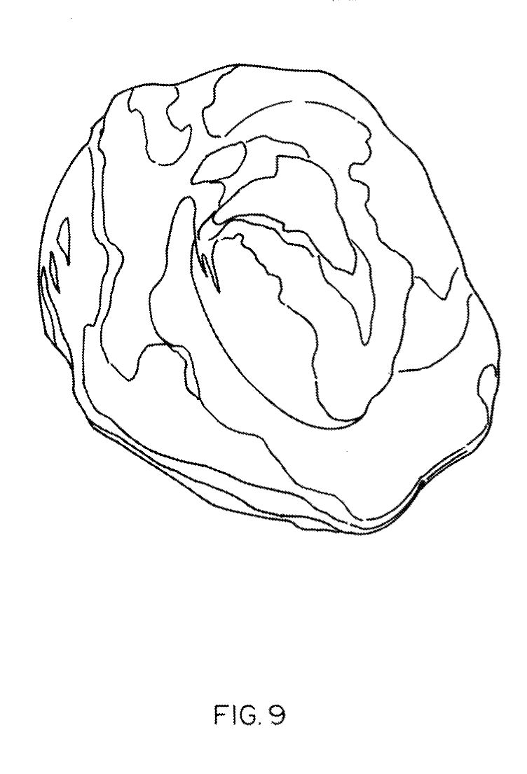

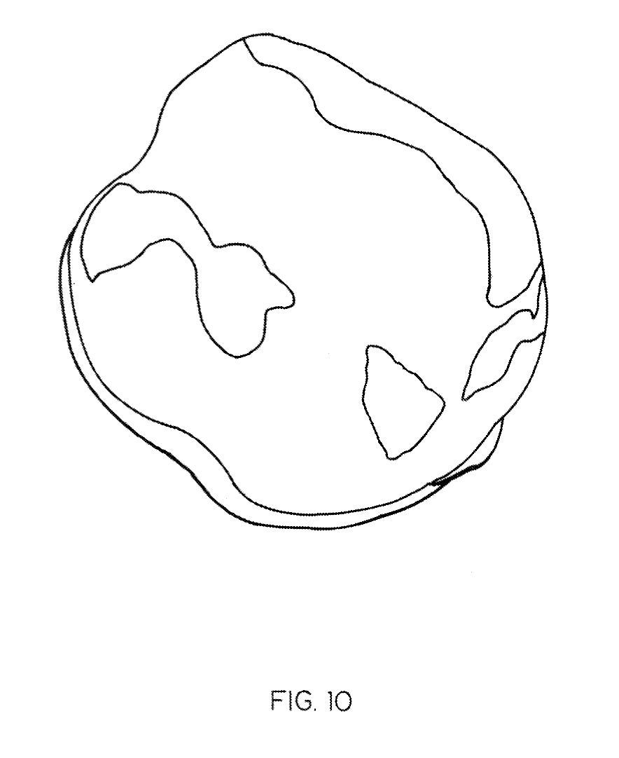

The first such measure is to provide dentists with fully sintered zirconia components with dimensions and shapes that are already close to the likely finished restoration. In the preferred embodiment, this is accomplished by employing data regarding tooth sizes and shapes garnered over many previous patient experiences. As shown in FIGS. 2 to 5, by employing such data, it is possible to develop a rough composite shape for any type of tooth (i.e., upper or lower molar, incisor, bicuspid, anterior tooth, etc.) that reflects all possible variations in size and shape from all such previous patient experiences. This rough composite can then be modified by a smoothing algorithm (see FIGS. 6 to 10) to provide a more practical configuration in terms of handling and safety to avoid sharp points and narrow edges and reduce the surface complexity. This smoothing approach also makes it more practical from an initial fabrication standpoint by facilitating the use of injection molding techniques at a pre-sintered or partially sintered stage before the dentist receives the near net shape fully sintered components.

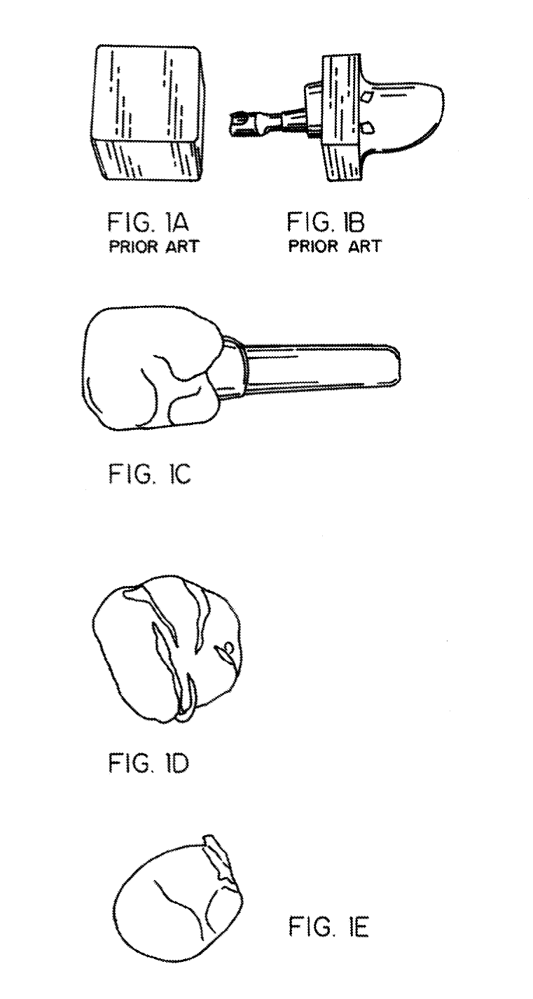

The second such measure is to integrate a zirconia mandrel into each of the near net shape components during the fabrication process. Current milling techniques require some way to affix the conventional ceramic block to the milling machine while permitting access to the block surfaces by the milling tool. This is normally accomplished by attaching a mandrel to the block. Such mandrels are usually made of metal, such as steel and are affixed by gluing the mandrel to the block to be at a known location and angle relative to the block surfaces. Unfortunately, such placement and gluing of the mandrel can be inaccurate. Such inaccuracy can be readily compensated for in a big block of zirconia by controlling the milling process accordingly. However, in a near net shape component, such compensation would require a larger starting size and thus more material to be removed. That would at least partially defeat the advantage of using a near net shape component by increasing the resulting time for milling to achieve the final restoration. This disadvantage is overcome in the present invention by employing a mandrel that is also made of zirconia and integrating it into the near net shape component. (See FIG. 1) Moreover, by employing such an integral zirconia mandrel, the current step of positioning, affixing and curing the mandrel/block interface is entirely obviated. Furthermore, by integrating a zirconia mandrel into the near net shape component, one can be far more accurate and consistent in mandrel location and angle and thus avoid the compensating enlargement of the near net shape component that would otherwise add to the amount of zirconia material that would need to be removed in a post-sintered milling process.

FIGS. 1a to 1e illustrate these unique and novel measures. More specifically, FIG. 1a shows the conventional block before milling and FIG. 1b shows the conventional milled part with affixed metal mandrel. FIG. 1c illustrates the near net shape component with integral zirconia mandrel. FIG. 1d shows the NNS component after final milling by the dentist.

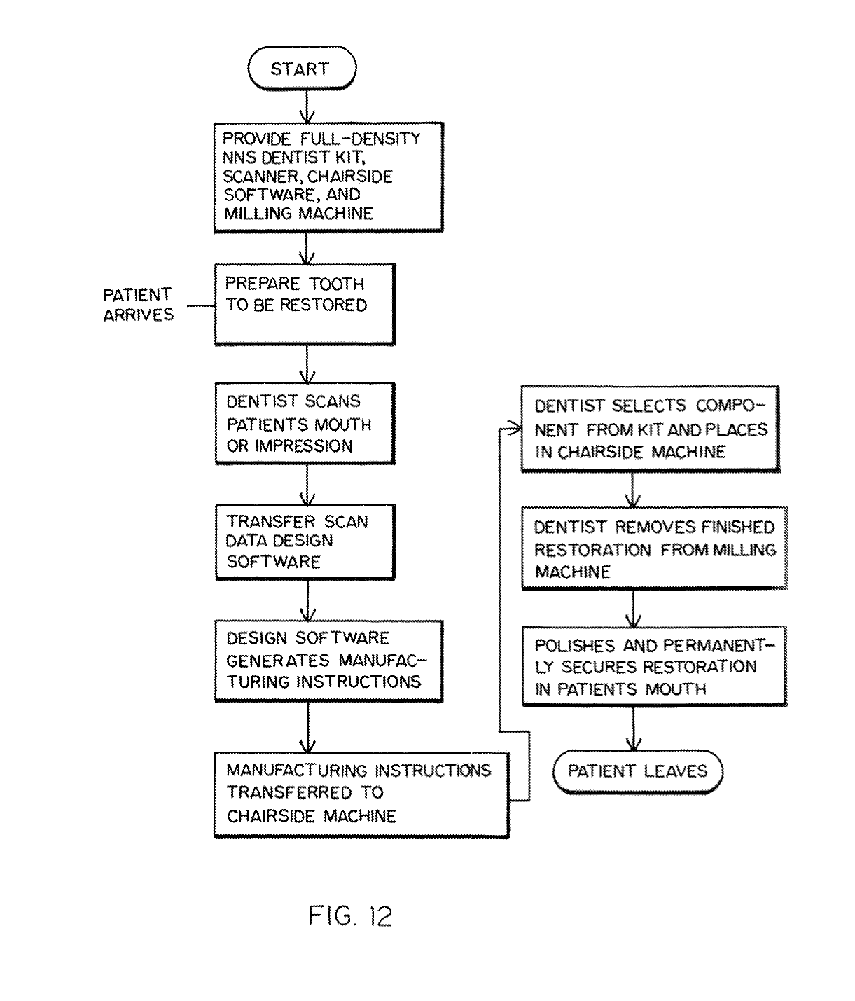

FIG. 12 illustrates, in flow chart format, the workflow for a dentist employing a near net shape (NNS) kit, a scanner and a chair-side milling machine to provide a patient with a dental restoration during one dental appointment. As indicated at the top of FIG. 12, the dentist will have been provided with the NNS component kit, scanner and chair-side milling machine with appropriate software. When the patient arrives, the tooth to be restored is prepared such as, for example, to receive a crown. Then the patient's mouth is scanned, or an impression is taken which can be scanned. Data from the scan is then transferred to design software for producing the restoration. This can be done locally, at a laboratory, or in the internet cloud through an automated design process depending on where the design software operation computer is located. If it is accomplished at a remote laboratory or in the internet cloud, the data is transferred over the internet.

Resulting manufacturing instructions are then transferred to the milling machine from the laboratory, internet cloud, or from the dentist's office equipment. At this point, the dentist selects the appropriate NNS component from the NNS zirconia kit. Each kit will contain at least the minimum number of components need to restore any tooth in the patient's mouth for both shape and shade. Shape is dictated by the nature of the tooth being restored. There may be as many as ten different shapes depending on whether the tooth is an upper or lower tooth, a molar, a bicuspid, an incisor, an anterior tooth, etc. Shade is dictated by the precise color of adjacent teeth and is typically one of seven different shade selections which have been determined to encompass the vast majority of human tooth color variations. Thus a complete kit for restoring any likely tooth will contain up to seventy components. In the preferred embodiment hereof, each such component will have an integral mandrel.

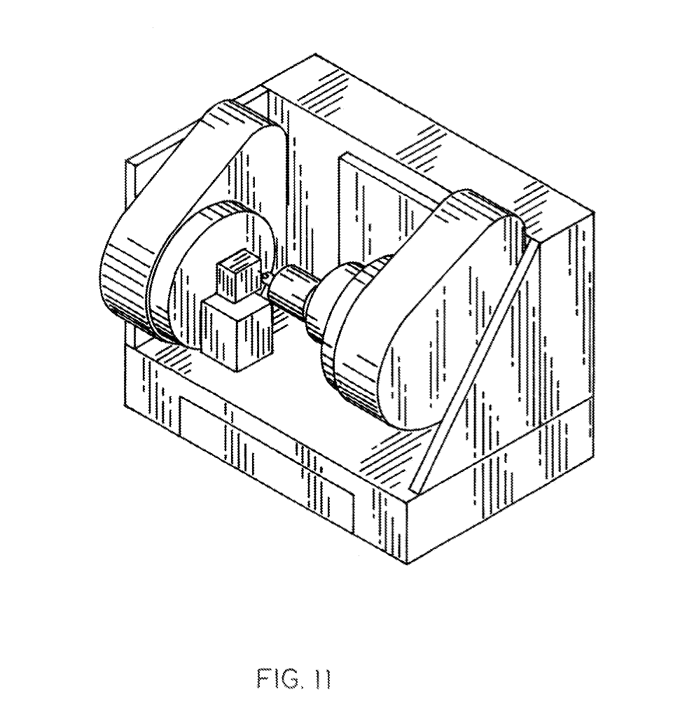

The dentist selects the appropriate NNS component and places it employing the integral mandrel, into the chair-side milling machine. (See FIG. 11). After such installation, the milling machine follows the transferred manufacturing instructions to mill the component into a finished restoration needing only separation of the mandrel and polishing or brazing. The dentist then installs the polished restoration and secures it in an otherwise conventional manner to complete the process.

It will now be understood that the present invention comprises a method and apparatus for preparing a fully contoured zirconia restoration that may be fabricated and installed in a single patient appointment. The preferred embodiments employ a kit comprising a plurality of near net shape, fully sintered zirconia components having a minimal amount of excess material to be removed by a small high speed milling machine in a matter of minutes. Each kit component is based on a composite of a particular type of tooth derived from a plurality of patient data and smoothed to promote safe handling. A scanner generates patient data to facilitate the design of milling machine instructions and selection of the most conforming kit component of appropriate shape and shade.

We claim:

1. A method for preparing a zirconia restoration comprising the steps of:
a) fabricating a plurality of near net shape fully sintered zirconia restoration components in selected shades and shapes at least one of which would be suitable for conversion into a fully formed zirconia restoration for a respective selected tooth of any particular dental patient;
b) generating electronic data representing a selected tooth to be restored from said particular dental patient;
c) providing a chair-side milling machine to remove zirconia material from a selected near net shape component to produce a completed restoration; and
d) using the electronic data of step b) to provide software instructions to the chair-side milling machine of step c) to convert the near net shape component to a restoration

2. The method recited in claim 1 wherein step b) is performed using a digital scanner.

3. The method recited in claim 1 wherein step a) is performed by employing at least seventy of said components representing seven distinct shades and ten distinct shapes.

4. The method recited in claim 1 wherein step c) is performed by selecting a near net shape component having the least amount of zirconia material that need be removed to produce said completed restoration.

5. The method recited in claim 1 wherein step a) further comprises the step of furnishing each said near net shape zirconia component with an integral zirconia mandrel at a precise location and angle to hold the component in said chair-side milling machine during step d).

6. The method recited in claim 5 further comprising the step of e) removing said milled restoration from said chair-side milling machine and f) separating said integral zirconia mandrel from said restoration.

7. The method recited in claim 6 further comprising the steps of g) polishing said restoration and h) installing said restoration onto said selected tooth of said particular dental patient.

8. The method of claim 1 wherein step a) comprises the steps of generating a composite shape of each kind of tooth to be restored and employing a smoothing operation to produce a near net shape component from said composite shape.

9. The method of claim 8 wherein said composite shape is based on a plurality of data derived from a plurality of each kind of tooth of different patients.

10. The method recited in claim 9 wherein said each kind of tooth comprises at least an upper molar, a lower molar, an upper incisor, a lower incisor, an upper bicuspid, a lower bicuspid, upper anterior teeth and lower anterior teeth.

11. An apparatus for preparing a zirconia restoration for a dental patient; the apparatus comprising:
a scanner for generating a digital representation of the dental patient's mouth adjacent a tooth to be restored;
a chair-side milling machine for milling a near net shape zirconia component into a full contour zirconia restoration;
a software application for designing a restoration and selecting appropriate near net shape component from kit, and
a plurality of fully sintered near net shape zirconia components in selected shades and shapes, at least one of which would be suitable for conversion into a fully formed zirconia restoration for said dental patient by milling away a minimal amount of excess zirconia material to restore said selected tooth.

12. The apparatus recited in claim 11 wherein each said near net shape component comprises an integral zirconia mandrel extending from said component at a selected location and at a selected angle.
